(19) United States
(12) Patent Application Publication
(10) Pub. No.: US 2008/0007550 A1
(43) Pub. Date: Jan. 10, 2008

(54) Current driven display for displaying compressed video

(75) Inventor: Andrei Cernasov, Ringwood, NJ (US)

Correspondence Address: Honeywell International, Inc.;Law Department AB2, P.O. Box 2245, Morristown, NJ, 07962-2245, US

(73) Assignee: Honeywell International, Inc.

(21) Appl. No.: 11/482,043

(22) Filed: Jul. 7, 2006

(51) Int. Cl. G09G 5/00; G06F 3/038; G06K 9/36; G06K 9/46; H04B 1/66

(52) U.S. Cl. 345/214; 382/232; 375/240

(57) ABSTRACT

A display is configured to display compressed video. The display includes a current driven display unit comprising light sources and a resistor coupled to each light source. Each resistor coupled to each light source has a conductivity related to a coefficient or partial coefficient of a transformation method.

### FIELD

This disclosure generally relates to displays. More particularly, the subject matter of this disclosure pertains to displays that are capable of displaying compressed video.

### BACKGROUND

Conventional displays receive video signals which represent either still or moving images. Conventional displays require that the video signals be uncompressed in order to properly display the video.

Typically, video is stored or transmitted in compressed format such as Joint Photographic Experts Group (JPEG) format for still images and Moving Pictures Experts Group (MPEG) for moving images. For example, in JPEG compression, the image is down sampled from the original 12- or 14-bit data back to 8 bits before performing the JPEG compression. Then, a large set of calculations must be performed on the image data to compress the image. Accordingly, any compressed video signal must be decompressed before a conventional display may display the video. Thus, a separate processor or a processor in the display must decompress the video signal before the video may be displayed.

Indeed, some digital devices that include a display, such as a digital camera or cell phone, may include a separate digital signal processor or other form of processor in order to perform decompression, such as JPEG decompression. Therefore, support of the decompression algorithm can consume a large amount of time and power in such digital devices.

It may be desirable to reduce the amount processing and power required for digital devices. Due to their popular acceptance, compressed video can be generated and handled by a wide variety of devices. For example, mobile devices like video cameras, mobile phones, personal digital assistants (PDAs), digital media players such as I-Pods etc., are now capable of providing compressed video, such as JPEG images or MPEG images. However, these devices must also conserve space used by the components and the amount of power they consume (since they run on batteries). It may also be desirable to speed the processing related to decompression, such as, for a security camera.

Accordingly, it would be desirable to systems and methods that efficiently implement decompression algorithms to display compressed video, such as a JPEG, image without the extra processing and hardware involved.

### SUMMARY

Embodiments of the present teaching are directed to a display configured to display compressed video. The display comprises a current driven display unit comprising light sources and a resistor coupled to each light source. Each resistor coupled to each light source has a conductivity related to a coefficient or partial coefficient of a transformation method.

Embodiments also are directed to a display configured to display transformed video. The display comprises a display unit comprising light source units. The each light source unit has a gain related to a coefficient or partial coefficient in a transformation method.

Embodiments are also directed to a device comprising a video source capable of providing a transformed video signal representing transformation coefficients or partial coefficients in a transformation method. The device also comprises a current driven display configured to display the transformed video signal based on the transformation coefficients.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a block diagram illustrating an exemplary display consistent with embodiments of the present teaching.

FIGS. 2-4, 5A, and 5B are diagrams illustrating an exemplary display unit consistent with embodiments of the present teaching.

FIG. 6 is a diagram illustrating a driving circuit consistent with embodiments of the present teaching.

### DETAILED DESCRIPTION

As noted above, in conventional displays, video, which includes still and moving images, is usually imputed to or stored in the displays in a compressed format, such as JPEG or MPEG. The display device uses “back-end” processing to decompress the video into a format that may be displayed by the display. Unfortunately, this type of “back-end” processing often requires the use of a separate digital signal processor or a separate computing device to perform the calculations necessary for the decompression algorithm. As such, conventional devices consume a large amount of power, take long times to decompress the video, and increase in size to accommodate additional hardware.

However, embodiments of the present teaching provide a display that implements “front-end” processing to perform part of a decompression or transformation algorithm when displaying video. In particular, the display uses transformation values of the compression or transformation algorithm directly as the video signal. The display includes a display unit which converts the video signal composed of transformation values into the actual viewable video.

For example, a display unit may be composed of video divisions, such as pixels. Each division is subdivided into sub-divisions, such as individual light sources. Each sub-division of display device receives a video signal corresponding to transformation coefficients of compressed video. The transformation coefficients may be complete coefficients or partial coefficients. The number of sub-divisions corresponds to the number of transformation coefficients or partial coefficients used by the compression algorithm.

Each sub-division of the display unit has a gain related to the transformation coefficient or partial coefficient of the compression or transformation algorithm. As such, the sub-divisions with gain transform the video signal received by the display into an actual viewable video signal. Accordingly, the display device produces video without having to decompress or transform the compressed or transformed video signal.

In addition, in order to simplify the display device, a reduced or compressed number of transformation coefficients or partial coefficients (such as 20) may be used. Also, sub-divisions across different divisions, but corresponding to the same transformation coefficient or partial coefficient may be connected in parallel.

Additionally, the “front end” processing may be achieved by including resistors in the display unit of the display. The resistors may have conductivity values proportional to the transformation functions of the compression algorithm.

By using “front-end” processing, embodiments of the present teaching can be implemented using less power, less memory, and reduced physical size. In addition, such “front-end” processing may significantly reduce or even eliminate delays in displaying video and power consumption of a display. Thus, for example, the performance of small size, battery powered, camera systems such as cell phones, web cameras, digital cameras, and surveillance systems may be enhanced.

Reference will now be made in detail to the present exemplary embodiments of the invention, examples of which are illustrated in the accompanying drawings. Wherever possible, the same reference numbers will be used throughout the drawings to refer to the same or like parts.

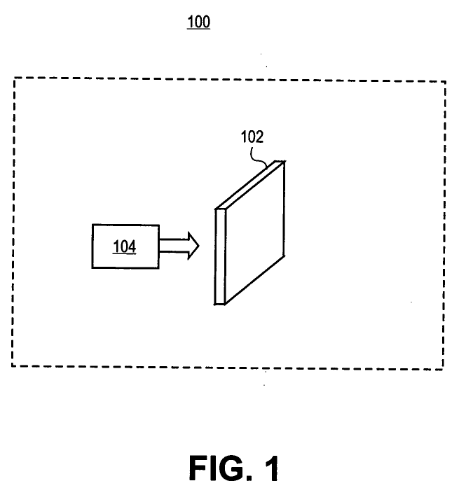

FIG. 1 is a block diagram illustrating an exemplary display 100 consistent with embodiments of the present teaching. Display 100 may be any type of display capable of displaying video, such as a still image or moving image, based on a video signal. For example, display 100 may be a current driven display. It should be readily apparent to those of ordinary skill in the art that display 100 illustrated in FIG. 1 represents a generalized schematic illustration and that other components may be added or existing components may be removed or modified.

Display 100 may be a stand alone display that receives video signals from an external device. For example, display 100 may be a monitor coupled to a computing device. Further, display 100 may be incorporated in a device that stores, receives, or captures compressed data. For example, display 100 may be a video screen in a cell phone or digital camera. One skilled in the art will realize that display 100 may be utilized with any type of device capable of producing, outputting, transmitting, or receiving video such as still images or moving images.

As illustrated in FIG. 1, display 100 includes a display unit 102 and a display control 104. Display unit 102 may comprise an array of controllable light sources. For example, if display 100 may be a current driven display, display unit 102 may include a light source such as light emitting diodes (LEDs). One skilled in the art will realize that display unit 102 may include any additional hardware, software, firmware, or combination thereof to produce video based on a video signal.

As illustrated in FIG. 1, display 100 also includes display control 104. Display control 104 may include any hardware, software, firmware or combination thereof to control display unit 102 and to provide a compressed video signal to display unit 102. One skilled in the art will realize that display unit 104 may include any additional hardware, software, firmware, or combination thereof to control display unit 102 and provide a compressed video signal to display unit 102.

Display unit 102 may perform “front-end” processing on the video signal received from display control 104. The video signal received may be a compressed video signal composed of transformation values of a compression or transformation algorithm. Display unit 102 may perform part of a decompression or inverse transformation algorithm on a compressed or transformed video signal being displayed by display 100. For example, the compression algorithm may be JPEG or MPEG.

Display unit 102 may be composed of multiple video divisions of light sources. For example, display unit 102 may be composed of multiple video divisions that represent the divisions in a video signal, such as pixels. To display compressed or transformed video, display unit 102 receives a signal based on the transformations values of the compression or transformation algorithm. Display unit 102 may perform “front-end” processing on the received a video signal which represents transformation values. Particularly, display unit 102 may performs a part of the decompression or inverse transformation algorithm on the video signal, representing the inverse transformation values, to produce actual viewable video.

As mentioned above, display 102 may be composed of multiple video divisions of light sources. Video divisions of display unit 102 may also be further sub-divided. For example, each sub-division may consist of a single light source. Each sub-division of display unit 102 may be related to the respective transformation value of the corresponding portion of video signal.

In such a case, each sub-division of display unit 102 receives a signal corresponding to a compressed or transformed video signal. Each sub-division of video divisions in display unit 102 generates video by receiving a specific transformation value of the compression or transformation algorithm corresponding to the sub-division position. For example, each sub-division of display unit 102 may be driven with the transformation coefficient or partial coefficient of a transformation algorithm. Display unit 102 may inverse transform the signal received by the corresponding sub-divisions of display unit 102 into actual video.

Particularly, each sub-division of the video division in display unit 102 may have a gain related to the decompression or inverse transformation algorithm. As such, the video signal, representing transformation values and driving each sub-division, may be changed into the actual viewable video signal. By this process, display 100 produces video without having to perform additional processing on the compressed or transformed video signal.

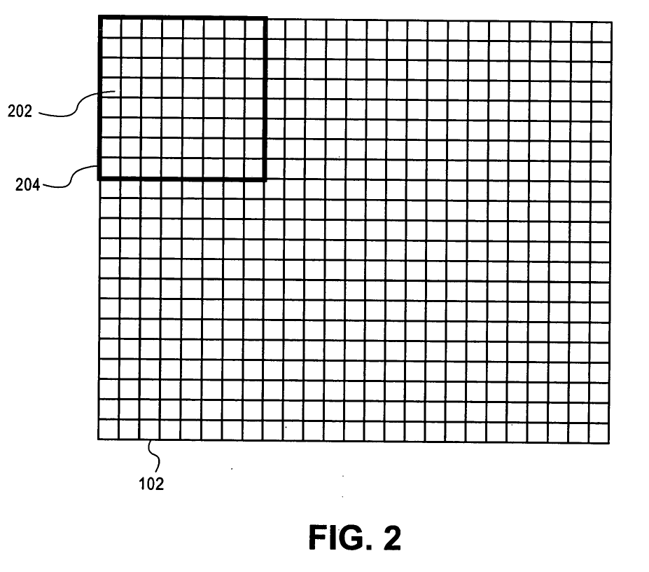

FIGS. 2-5 illustrate an exemplary display unit 102 which may be used in display 100. Display unit 102 may be configured to be used with transform encoding for video such as the JPEG compression algorithm for a still image or MPEG compression algorithm for moving images. Display unit 102 alters a video signal corresponding to the transformation coefficients or partial coefficients of the JPEG or other transformation algorithm such that the video signal received by display unit 102 is converted to actual viewable video. It should be readily apparent to those of ordinary skill in the art that display unit 102 illustrated in FIGS. 2-5 represents generalized schematic illustrations and that other components may be added or existing components may be removed or modified.

The JPEG algorithm is designed to compress either color or grey-scale digital images. Conceptually, JPEG compresses a digital image based on a mathematical tool known as the DCT and empirical adjustments to account for the characteristics of human vision.

The basic DCT can be expressed by the formula:

$$D ( i , j ) = \frac{2}{\sqrt{MN}} C ( i ) C ( j ) {\sum }_{m = 0}^{m = M - 1} {\sum }_{n = 0}^{n = N - 1} p ( m , n ) cos [ \frac{( 2 m + 1 ) i π}{2 M} ] cos [ \frac{( 2 n + 1 ) j π}{2 N} ]$$

where C(i) and C(j) coefficients are:

C(k)=1/\sqrt{2} (for k=0), or =1 (for k>0); and

where p(m,n) represents the pixel values, either intensity or color.

JPEG applies the DCT to an elementary image area (called an “image block”) that are 8 pixels wide and 8 lines high. This causes the basic DCT expression to simplify to:

$$D ( i , j ) = \frac{1}{4} C ( i ) C ( j ) {\sum }_{m = 0}^{m = 7} {\sum }_{n = 0}^{n = 7} p ( m , n ) cos [ \frac{( 2 m + 1 ) i π}{16} ] cos [ \frac{( 2 n + 1 ) j π}{16} ]$$

Therefore, in essence, JPEG uses the DCT to calculate the amplitude of spatial sinusoids that, when superimposed, can be used to recreate the original image.

In order to compress the data for an image, JPEG also combines a set of empirical adjustments to the DCT. The empirical adjustments have been developed through experimentation and may be expressed as a matrix of parameters that synthesizes or models what a human vision actually sees and what it discards. Through research, it was determined that a loss of some visual information in some frequency ranges is more acceptable than others. In general, human eyes are more sensitive to low spatial frequencies than to high spatial frequencies. As a result, a family of quantization matrices Q was developed. In a Q matrix, the bigger an element, the less sensitive the human eye is to that combination of horizontal and vertical spatial frequencies. In JPEG, quantization matrices are used to reduce the weight of the spatial frequency components of the DCT processed data, i.e., to model human eye behavior. The quantization matrix Q₅₀ represents the best known compromise between image quality and compression ratio and is presented below.

$${Q}_{50} = [ \begin{matrix}16 & 11 & 10 & 16 & 24 & 40 & 51 & 61 \\ 12 & 12 & 14 & 19 & 26 & 58 & 60 & 55 \\ 14 & 13 & 16 & 24 & 40 & 57 & 69 & 56 \\ 14 & 17 & 22 & 29 & 51 & 87 & 80 & 62 \\ 18 & 22 & 37 & 56 & 68 & 109 & 103 & 77 \\ 24 & 35 & 55 & 64 & 81 & 104 & 113 & 92 \\ 49 & 64 & 78 & 87 & 103 & 121 & 120 & 101 \\ 72 & 92 & 95 & 98 & 112 & 100 & 103 & 99\end{matrix} ]$$

For higher compression ratios, poorer image quality, the Q₅₀ matrix can be multiplied by a scalar larger than 1 and clip all results to a maximum value of 255. For better quality images, but less compression, the Q₅₀ matrix can be multiplied by a scalar less than 1.

Therefore, the JPEG algorithm can be expressed as the following equation:

$$K ( i , j ) = \frac{1}{4} \frac{C ( i ) C ( j )}{Q ( i , j )} {\sum }_{m = 0}^{m = 7} {\sum }_{n = o}^{n = 7} p ( m , n ) cos [ \frac{( 2 m + 1 ) i π}{16} ] cos [ \frac{( 2 n + 1 ) j π}{16} ]$$

Of note, the application of the quantization matrix with the DCT essentially eliminates many of the frequency components of the DCT alone. The example below illustrates this phenomenon.

For clarity of presentation, the example is limited to a single 8×8 image block from a stock image. For example, suppose the image array I for a single image block is:

$$I = [ \begin{matrix}170 & 153 & 153 & 153 & 160 & 160 & 153 & 134 \\ 170 & 153 & 153 & 160 & 160 & 160 & 153 & 134 \\ 170 & 110 & 153 & 160 & 160 & 153 & 153 & 134 \\ 160 & 110 & 134 & 165 & 165 & 153 & 134 & 110 \\ 160 & 134 & 134 & 165 & 160 & 134 & 134 & 110 \\ 165 & 134 & 134 & 160 & 223 & 134 & 110 & 134 \\ 165 & 134 & 160 & 196 & 223 & 223 & 110 & 134 \\ 165 & 160 & 196 & 223 & 223 & 254 & 198 & 160\end{matrix} ]$$

Initially, it is noted that all values in the I matrix are positive. Therefore, before continuing, the apparent DC bias in the image can be removed by subtracting a value, such as 128, from the matrix I. A new matrix I′ results and is provided below.

$${I}^{′} = [ \begin{matrix}42 & 25 & 25 & 25 & 32 & 32 & 25 & 6 \\ 42 & 25 & 25 & 32 & 32 & 32 & 25 & 6 \\ 42 & - 18 & 25 & 32 & 32 & 25 & 25 & 6 \\ 32 & - 18 & 6 & 37 & 37 & 25 & 6 & - 18 \\ 32 & 6 & 6 & 37 & 32 & 6 & 6 & - 18 \\ 37 & 6 & 6 & 32 & 95 & 6 & - 18 & 6 \\ 37 & 6 & 32 & 68 & 95 & 95 & - 18 & 6 \\ 37 & 32 & 68 & 95 & 95 & 126 & 70 & 32\end{matrix} ]$$

From matrix algebra, the application of the DCT to the image array I is equivalent to multiplying the DCT matrix T by the matrix I. The result may then be multiplied with the transpose of T. From the DCT definition, the elements of the T matrix can be calculated by the equation:

$$T ( i , j ) = \sqrt{\frac{2}{M}} C ( i ) cos [ \frac{( 2 j + 1 ) i π}{2 M} ]$$

where i and j are row and column numbers from 0 to 7. For convenience, the T matrix is presented below.

$$T = [ \begin{matrix}0.3536 & 0.3536 & 0.3536 & 0.3536 & 0.3536 & 0.3536 & 0.3536 & 0.3536 \\ 0.4904 & 0.4157 & 0.2728 & 0.0975 & - 0.0975 & - 0.2778 & - 0.4157 & - 0.4904 \\ 0.4619 & 0.1913 & - 0.1913 & - 0.4619 & - 0.4619 & - 0.1913 & 0.1913 & 0.4619 \\ 0.4157 & - 0.0975 & - 0.4904 & - 0.2778 & 0.2778 & 0.4904 & 0.0975 & - 0.4157 \\ 0.3536 & - 0.3536 & - 0.3536 & 0.3536 & 0.3536 & - 0.3536 & - 0.3536 & 0.3536 \\ 0.2778 & - 0.4904 & 0.0975 & 0.4157 & - 0.4157 & - 0.0975 & 0.4904 & - 0.2778 \\ 0.1913 & - 0.4619 & 0.4619 & - 0.1913 & - 0.1913 & 0.4619 & - 0.4619 & 0.1913 \\ 0.0975 & - 0.2778 & 0.4157 & - 0.4904 & 0.4904 & - 0.4157 & 0.2778 & - 0.0975\end{matrix} ]$$

Continuing now with JPEG, the DCT may be applied to the image matrix I′ by multiplying it with T on the left and the transpose of T on the right. Rounding the result, the following matrix I″ is obtained.

$${I}^{″} = [ \begin{matrix}233 & 21 & - 103 & 78 & 51 & 18 & 25 & 8 \\ - 75 & 19 & 71 & - 21 & - 18 & 26 & - 18 & 12 \\ 104 & - 22 & - 14 & 5 & - 36 & - 11 & 16 & - 18 \\ - 47 & 31 & 10 & - 2 & 27 & - 38 & - 19 & 11 \\ 13 & - 7 & 3 & - 3 & - 29 & 25 & - 12 & - 10 \\ - 16 & - 1 & - 19 & 16 & 16 & - 8 & 25 & - 4 \\ 5 & - 10 & 11 & - 9 & 10 & 2 & - 9 & 24 \\ - 2 & 1 & 3 & - 3 & - 9 & 12 & 9 & - 9\end{matrix} ]$$

In order to consider the empirical data of human vision, each element of the I″ matrix is divided by the corresponding element of a quantization matrix and each result is rounded. For example, if quantization matrix Q₅₀ is used, the result I″ Q₅₀ is expressed below.

$${I}^{″} {Q}_{50} = [ \begin{matrix}15 & 2 & - 10 & 5 & 2 & 0 & 0 & 0 \\ - 6 & 2 & 5 & - 1 & - 1 & 0 & 0 & 0 \\ 7 & - 2 & - 1 & 0 & - 1 & 0 & 0 & 0 \\ - 3 & 2 & 0 & 0 & 1 & 0 & 0 & 0 \\ 1 & 0 & 0 & 0 & 0 & 0 & 0 & 0 \\ - 1 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix} ]$$

Of note, most of the elements in the result matrix round off to 0. In particular, only 19 of the 64 transformation coefficients are non-zero values. That is, JPEG has eliminated those components that were too small to overcome the human eye's lack of sensitivity to their spatial frequency.

If the quality level is dropped by using a quantization matrix, such as Q₁₀, approximately only 7 nonzero coefficients remain. Likewise, if the quality level is increased by using a quantization matrix, such as Q₉₀, approximately 45 coefficients remain. Therefore, for the most part, the JPEG algorithm utilizes relatively few of the 64 possible transformation coefficients of the DCT.

The number of terms that may bring a non-negligible contribution to the value of K(i,j) depends of the desired fidelity of the image. For example, only 10 to 30 of these 64 terms may bring a non-negligible contribution to the value of K(i,j), with 20 being the most common number. The JPEG algorithm obtains compression replacing the measurement and transmission of 64 pixel values (for each 8×8 tile) with the calculation and transmission of K(i,j) coefficient values. For example, if only 20 of these 64 terms bring a non-negligible contribution to the value of K(i,j), only these 20 coefficient values may be used to represent the image.

As discussed above, at the core of the JPEG algorithm is the division of the DCT coefficients of 8×8 tiles of the image of interest by the experimentally determined quantization values Q(i,j). To recover the actual image, the inverse Direct Cosine Transformation is applied to the K(i,j) coefficients.

The actual given value for a viewable pixel m,n would be given by:

$$p ( m , n ) = \frac{1}{4} {\sum }_{i = 0}^{i = 7} {\sum }_{i = 0}^{i = 7} C ( i ) C ( j ) Q ( i , j ) K ( i , j ) cos \frac{( 2 m + 1 ) i π}{16} cos \frac{( 2 n + 1 ) j π}{16}$$

Where:

p(m,n) is the pixel illumination for the image at the position m,n (within the 8×8 tile), Q(i,j) measures the eye sensitivity at the spatial frequencies i and j, and C(k) is given by:

$$C ( k ) = \{ \begin{matrix}\frac{1}{\sqrt{2}} & for & k = 0 \\ 1 & for & k > 0\end{matrix}$$

Returning to FIG. 2, display 100 by use of display unit 102 produces actual video by using a video signal composed of K(i,j) values. Display unit 102 may be composed of multiple video divisions 202 of light sources. Each video division 202 may be divisions of the video, such as pixels. Video divisions 202 may be grouped into blocks. For example, video divisions 202 may be grouped into 8 video divisions by 8 video divisions block 204.

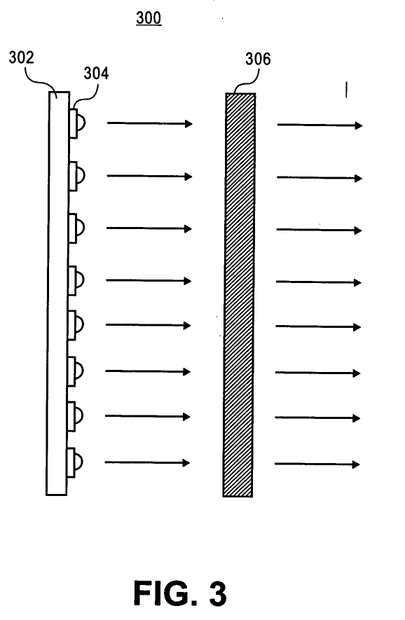

FIG. 3 is a side view diagram illustrating an exemplary current driven display unit 300 consistent with embodiments of the present teaching. Current driven display unit 300 may be used as display unit 102 in display 100. It should be readily apparent to those of ordinary skill in the art that current driven display unit 300 illustrated in FIG. 3 represents a generalized schematic illustration and that other components may be added or existing components may be removed or modified.

Current driven display unit 300 includes a light source array 302. Light source array 302 includes multiple light sources 304. Light sources 304 may emit light at different intensities by applying different current values to light sources 304. For example, light source array 302 may be an array of light emitting diodes (LEDs).

Current driven display unit 300 displays video by driving different light sources 304 at different current values to obtain various intensities across current driven display-unit 300. For example, if display 100 includes a current driven display unit 300, control unit 104 may include a driver circuit to drive light source array 302 based on a video signal. According to embodiments, video divisions of display unit 300 may be composed of multiple light sources 304. Further, sub-divisions of the video division may be individual light sources 304.

Current driven display unit 300 may also include display filter 306. Display filter 306 may be included to provide different colors for the light emitted from light source array 302. Display filter 306 also may be included to create a uniform light distribution emitted from light source array 302.

To properly display video using the transformation coefficients K(i,j), each division 202 of display unit 102 may be further divided into sub-divisions, such as sub-pixels. For example, if current driven display unit 300 is utilized, sub-divisions of video divisions 202 may be individual light sources 304.

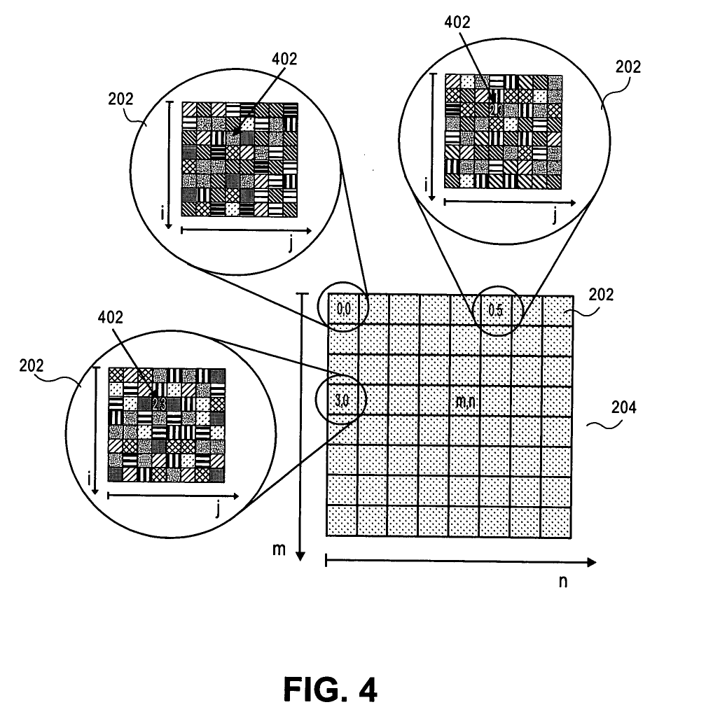

FIG. 4 is a diagram illustrating exemplary sub-divisions of video divisions 202 in an 8×8 block 204 of video divisions 202. As illustrated in FIG. 4, each video division 202 may represent a pixel m,n in display 102. Each video division 202 may be divided into sub-divisions 402. Each sub-division 402 may represent a single light source of display unit 102. For example, if display unit 300 is utilized, sub-divisions 402 may represent a single light source 304.

The number of the sub-divisions 402 may be equal to the number of transformation coefficients or partial coefficients, for example JPEG coefficients K(i,j). For example, as illustrated in FIG. 4, a particular video division 202 may be sub-divided into 64 sub-divisions 402. One skilled in the art will realize that the number of divisions is exemplary and that display unit 102 may be divided into any number of divisions and sub-divisions as required by the compression method.

Display 100 produces actual viewable video by driving display unit 102 with a video signal corresponding to transform coefficients K(i,j). Each sub-division 402 of display unit 102 is driven with the corresponding transform coefficient K(i,j). Then, each sub-division 402 may transform the corresponding video into actual viewable video. To achieve this, sub-divisions 402 have a gain related to the corresponding inverse transformation coefficient of the transformation algorithm. The gain for each sub-division may be achieved by using any hardware, software, firmware, or combination thereof to increase or reduce the video signal. For example, if the JPEG compression algorithm is utilized, the gain may be given as follows:

$$C ( i ) C ( j ) Q ( i , j ) cos \frac{( 2 m + 1 ) i π}{16} cos \frac{( 2 n + 1 ) j π}{16} .$$

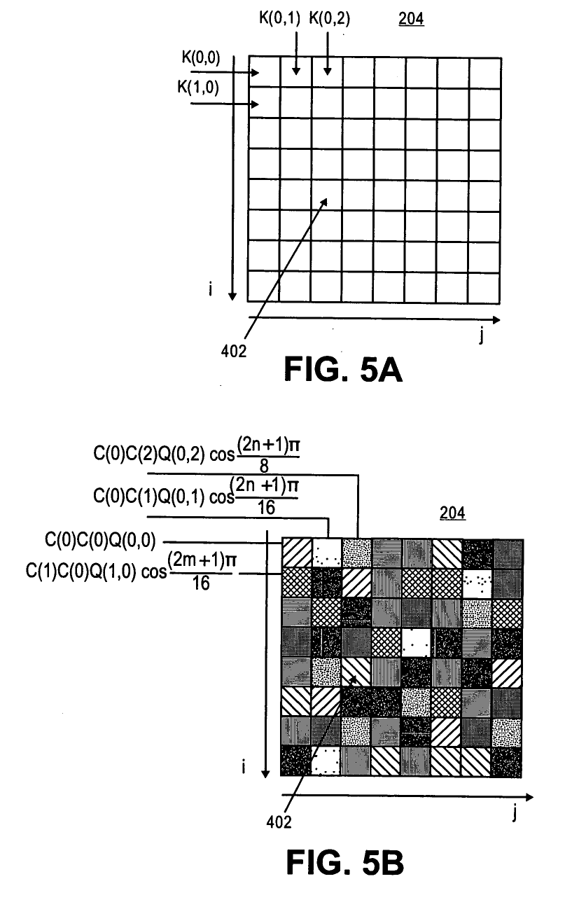

FIGS. 5A and 5B are diagrams illustrating the transform coefficients supplied to display unit 102 and the gain of the sub-divisions of display unit 102 for a particular pixel m,n. As illustrated in FIG. 5A, sub-divisions 402 may be supplied with different transformation coefficients. For example, the transform coefficients may be supplied to display unit 102, for example, as follows:

Sub-division 0,0-K(0,0);

Sub-division 1,0-K(1,0);

Sub-division 0,1-K(0,1); and

Sub-division 0,2-K(0,2)

As such, the corresponding sub-division 402 may have a gain related to the inverse transform coefficients in order to transform the video signal received by sub-divisions 402 into actual viewable video. For example, as illustrated in FIG. 5B, sub-division 402 corresponding to K(0,0) may have a gain proportional to

C(0)C(0)Q(0,0).

Sub-division 402 corresponding to K(1,0) may have a gain proportional to

$$C ( 1 ) C ( 0 ) Q ( 1 , 0 ) cos \frac{( 2 m + 1 ) π}{16} .$$

Sub-division 402 corresponding to K(0,1) may have a gain proportional to

$$C ( 0 ) C ( 1 ) Q ( 0 , 1 ) cos \frac{( 2 n + 1 ) π}{16} .$$

Sub-division 402 corresponding to K(0,2) may have a gain proportional to

$$C ( 0 ) C ( 2 ) Q ( 0 , 2 ) cos \frac{( 2 n + 1 ) π}{8} .$$

where m,n is the position of the division in the 8×8 block. Accordingly, the video output by display 100 after processing by display unit 102 would appear as actual viewable video.

One skilled in the art will also realize that any transformation or compression/decompression algorithm may be utilized to determine the number sub-divisions of video divisions 202 and the gains of display unit 106. For example, the number of sub-divisions of video divisions 202 and the gains of display unit 102 may be related to transformation values in the MPEG algorithm.

FIGS. 2-4, 5A, and 5B illustrate 64 K(i,j) sub-divisions for each division (or individual filter). Display unit 102 may be divided into less sub-divisions such as 20. One skilled in the art will realize that display unit 102 may be divided into any number of sub-divisions depending on the desired number of transform coefficients or partial coefficients.

Since the video signal supplied to each corresponding sub-division in different divisions of a common 8×8 block of display unit 102 represent the same transform coefficient or partial coefficient, all the sub-divisions corresponding to the same transform coefficient or partial coefficient may be connected in parallel in order to receive the same signal. For example, a driving circuit may be utilized to supply K(0,1) to all sub-divisions 0,1 in pixels m,n in an 8×8 block. Sub-divisions 302 may be, for example, the individual light sources. The driving circuit may be included in display control 104.

As mentioned above, display 100 includes a display that is capable of displaying a video signal composed of transformation values as actual viewable video. According to other embodiments of the invention, display 100 may be a current driven display. According to these embodiments, the “front end” processing may be achieved by including resistors in display unit 102 of display 100. The resistors provide gain for the light sources of display unit 102 to convert the video signal composed of transformation values into actual viewable video. The resistors may have conductivity values related to the transformation coefficients or partial coefficients of the compression or transformation algorithm.

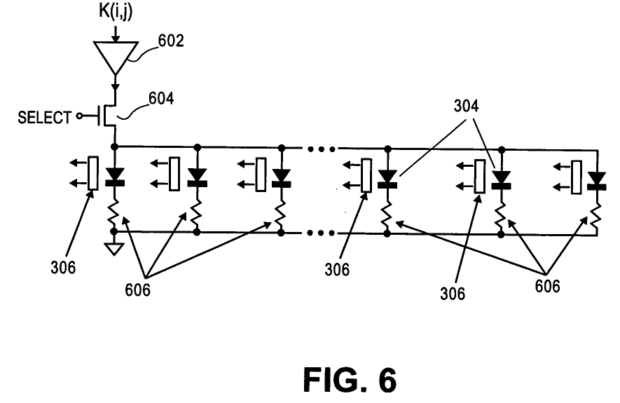

FIG. 6 is a diagram illustrating an exemplary driving circuit 600 supplying a video signal to corresponding light sources 304, in different divisions of an 8×8 block in light source array 302, consistent with embodiments of the present teachings.

As illustrated in FIG. 6, driving circuit 600 may be used with a current driven display unit 300 that comprises light sources such as light emitting diodes 304. For example, driving circuit 800 may be utilized to supply K(0,1) to all light sources in the 0,1 position in pixels m,n in an 8×8 block of light source array 302. Driving circuit 600 may be included in display control 104. Since the video signal supplied to each corresponding light source in different divisions of display unit 102 represent the same transform coefficient or partial coefficient, all the light sources having the same transform coefficient may be connected in parallel in order to receive the same signal.

It should be readily apparent to those of ordinary skill in the art that driving circuit 600 illustrated in FIG. 6 represents a generalized schematic illustration and that other components may be added or existing components may be removed or modified. Further, one skilled in the art will realize that display 100 may have a driving circuit 600 for each different transform coefficient K(i,j).

As illustrated in FIG. 6, driving circuit 600 comprises an amplifier 602 and a transistor 604 coupled to amplifier 602. Amplifier 602 amplifies the signal supplied, which corresponds to K(i,j), to light sources 304 of current driven display unit 300. Transistor 604 controls when the video signal, which corresponds to K(i,j), is supplied to light sources 304 of current driven display unit 300.

As illustrated in FIG. 6, transistor 604 may be coupled in parallel to each anode of LEDs 304 for a particular K(i,j) value in all pixels of an 8×8 block. The cathodes of LEDs 304 may be connected in parallel to one side of resistors 606. The other side of resistors 606 may be coupled to ground. As mentioned above, resistors 606 may have conductivity values are related to the transformation coefficients or partial coefficients of the transformation algorithm. As such, the video signal corresponding to K(i,j) may be supplied directly to LEDs 304. Resistors 806 may alter the illumination of LEDs 304 in order to produce actual viewable video.

In general, the resistor corresponding to the sub-division (i,j) of video division (m,n) for a certain JPEG 8×8 block will have a conductivity proportional to:

$$C ( i ) C ( j ) Q ( i , j ) cos \frac{( 2 m + 1 ) i π}{16} cos \frac{( 2 n + 1 ) j π}{16} .$$

Accordingly, the video output by display 100 would appear as actual viewable video without applying a transformation algorithm to the video signal.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. A display configured to display compressed video, said display comprising:
a current driven display unit comprising light sources; and
a resistor coupled to each light source, wherein each resistor coupled to each light source has a conductivity related to a coefficient of a transformation method.

2. The display of claim 1, wherein light sources are arranged in video blocks.

3. The display of claim 2, wherein the light sources of the display unit represent sub-divisions of a block.

4. The display of claim 3, further comprising:
driving circuits coupled to light sources representing corresponding sub-divisions of different video blocks.

5. The display of claim 4, wherein the driving circuit comprises:
a transistor coupled to multiple light sources related to a coefficient of a transformation method; and
an amplifier coupled to the transistor.

6. The display of claim 4, wherein the driving circuits provide a signal representing transformed video to light sources representing corresponding sub-divisions.

7. The display of claim 3, wherein each video block comprises 8 sub-divisions by 8 sub-divisions.

8. The display of claim 3, wherein each video block comprises less than 8 sub-divisions by 8 sub-divisions.

9. The display of claim 3, wherein the resistors coupled to light sources related to corresponding sub-divisions have conductivities related to coefficients or partial coefficients of an image transform.

10. The display of claim 9, wherein the coefficients or partial coefficients are terms of product terms in sub-terms of a product transform.

11. The display of claim 10, wherein a sum of product transforms is defined by the JPEG compression algorithm.

12. A display configured to display transformed video, the display comprising:
a display unit comprising light source units; wherein the each light source unit has a gain related to a coefficient or partial coefficient of a transformation method.

13. The display of claim 12, wherein a light source unit comprises:
a current driven light source; and
a resistor coupled to the light source, wherein the resistor coupled to the light source has a conductivity related to a coefficient or partial coefficient of a transformation method.

14. The display of claim 12, wherein light source units are arranged in video blocks.

15. The display of claim 13, wherein the light source units represent sub-divisions of a video block.

16. The display of claim 15, further comprising:
a set of driving circuits coupled to the light source units, wherein each driving circuit is coupled to light source units corresponding sub-divisions of different video blocks.

17. The display of claim 12, wherein corresponding sub-divisions of video blocks relate to coefficients or partial coefficients of an image transform.

18. The display of claim 17, wherein the coefficients or partial coefficients are terms of product terms in sub-terms of a product transform.

19. A device, comprising:
a video source capable of providing a transformed video signal representing transformation coefficients in a transformation method; and
a current driven display configured to display the transformed video signal based on the transformation coefficients or partial coefficients.
